(19) United States
(12) Patent Application Publication
(10) Pub. No.: US 2007/0127320 A1
(43) Pub. Date: Jun. 7, 2007

(54) Device for educational entertainment

(75) Inventors: Michael S. Caffrey, Kirkland, WA (US); John Hendricks, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Screenlife, LLC, Seattle, WA (US)

(21) Appl. No.: 11/526,063

(22) Filed: Sep. 22, 2006

Related U.S. Application Data
(60) Provisional application No. 60/719,372, filed on Sep. 22, 2005.

(51) Int. Cl. G11B 21/08

(52) U.S. Cl. 369/30.02

(57) ABSTRACT

An educational/entertainment apparatus generally includes a controller (20) for use with a multimedia device (10). The controller includes a platform (26) for receiving a disc (50), the disc including a plurality of graphical images on at least one surface that correspond to a plurality of multimedia options, the disc also including an identifier that identifies the disc. The controller further includes a reader (42) for reading the identity of the disc, a selector (28) for a user to select one of the plurality of graphical images, and a controller/transmitter (61, 63) for determining the selected graphical image and transmitting a multimedia control signal (60) that contains information that identifies the selected graphical image.

### CROSS-REFERENCE TO RELATED APPLICATION

This application claims the benefit of U.S. Provisional Patent Application No. 60/719,372, filed Sep. 22, 2005, the disclosure of which is hereby expressly incorporated by reference.

### TECHNICAL FIELD

The embodiments described herein relate generally to devices for educational entertainment and, more specifically, to children's devices for educational entertainment.

### BACKGROUND

The spinning, audio-educational toy sold by Mattel Inc./Fisher Price under the Trademark “SEE 'N SAY,” has for years helped children learn the names and sounds of various barnyard animals (such as cows, pigs, roosters, etc.). The SEE 'N SAY® toy is a mechanical device with a variety of images printed on its face in a circular arrangement similar to the arrangement of numbers on a clock face. At the center of the “clock face” is a large arrow that can be pointed by the child-user to any one of a variety of animals. Moving the arrow toward a specific animal on the perimeter of the device and pulling a string, a lever, or otherwise activating the toy causes a short, recorded audio message to play. For example, pointing to the cow and activating the device would cause the device to play the recording “The cow says Moo.” For more information about how the SEE 'N SAY® mechanical device works, see http://entertainment.howstuffworks.com/see-say.htm.

In contrast to contemporary multimedia players that allow children to visually as well as aurally interact with their chosen forms of educational entertainment, the SEE 'N SAY® mechanical device is limited to audio interaction. This invention is directed to combining educational entertainment of the type provided by the original SEE 'N SAY® toy with the technology enhancements provided by multimedia devices and systems, such as DVD players combined with televisions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with another embodiment of the present disclosure, a controller for use with a multimedia device is provided. The controller includes a platform for receiving a disc, the disc including a plurality of graphical images on at least one surface that correspond to a plurality of multimedia options, the disc also including an identifier that identifies the disc. The controller further includes a reader for reading the identity of the disc, a selector for a user to select one of the plurality of graphical images, and a controller/transmitter for determining the selected graphical image and transmitting a multimedia control signal that contains information that identifies the selected graphical image.

In accordance with another embodiment of the present disclosure, an educational/entertainment apparatus is provided. The educational/entertainment apparatus includes a DVD-Video disc containing a plurality of video clips, a disc including a plurality of graphical images on at least one face of the disc that are related to the video clips, and a controller for reading the disc and controlling the operation of the multimedia device.

In accordance with still other embodiments of the present disclosure, an educational/entertainment apparatus is provided. The educational/entertainment apparatus includes a multimedia device for displaying video clips in response to control signals, a disc including a plurality of graphical images on at least one face of the disc that are related to the video clips, and a controller for reading the disc and controlling the operation of the multimedia device.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an isometric view of a DVD controller formed in accordance with the present invention used by a child to control the images displayed on the television by a DVD player;

FIG. 2 is an isometric view of one embodiment of a child's educational DVD controller suitable for use in FIG. 1;

FIG. 3 is an isometric view of the platform of a child's DVD controller illustrated in FIG. 2 with a disc storage compartment in the open position and an interchangeable disc being inserted;

FIG. 4 is a top view of the platform of a child's DVD controller illustrated in FIGS. 2-3;

FIG. 5 is a cross-sectional view of the platform of a child's DVD controller illustrated in FIGS. 2-4 with the interchangeable disc being inserted;

FIG. 6 is a functional flow diagram illustrating the operation of the child's DVD controller illustrated in FIGS. 2-5;

FIG. 7 is a functional flow diagram illustrating the operation of the DVD player in response to the operation of the child's DVD controller illustrated in FIGS. 2-5;

FIG. 8 is an alternative functional flow diagram illustrating the operation of the DVD player in response to the operation of the child's DVD controller illustrated in FIGS. 2-5;

FIG. 9 is an alternative functional flow diagram illustrating the operation of the child's DVD controller illustrated in FIGS. 2-5;

FIG. 10 is an isometric view of a first alternate embodiment of a child's DVD controller; and

FIG. 11 is an isometric view of a second alternate embodiment of a child's DVD controller.

### DETAILED DESCRIPTION

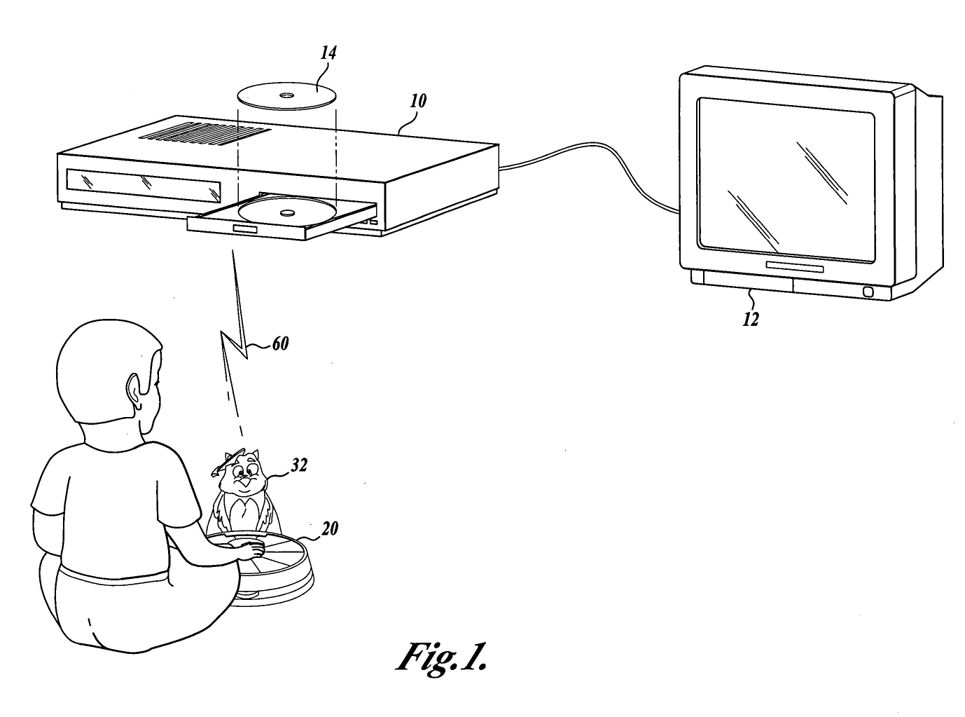

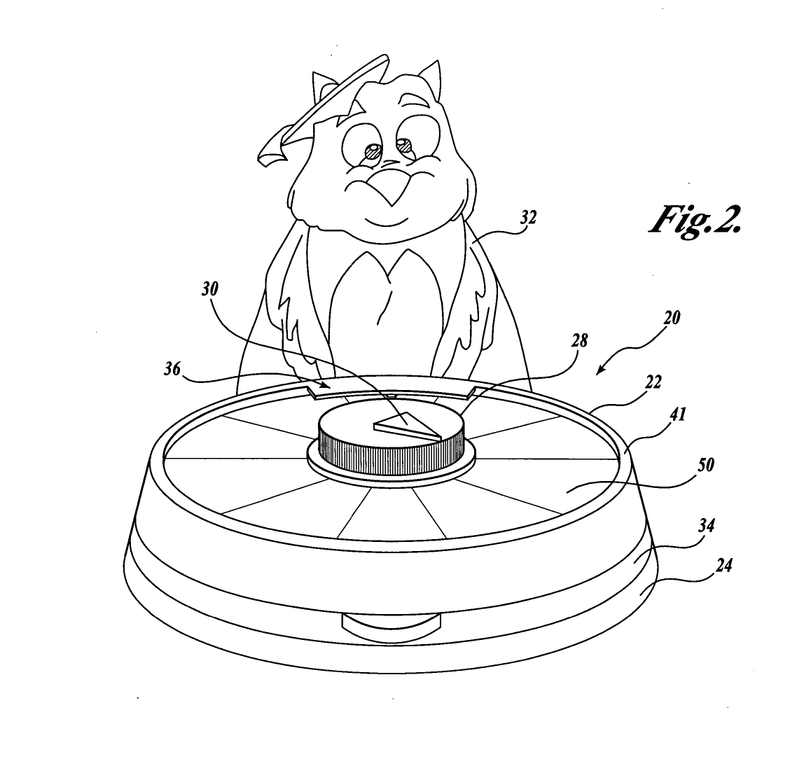

A device for educational entertainment constructed in accordance with one embodiment of the present invention may be best understood by referring to FIGS. 1 and 2. The device includes a child's DVD controller 20 used in conjunction with a multimedia device or system, such as a DVD player 10 and a television 12, to educate and/or entertain a child. As will be better understood from the following description, a disc inserted into the DVD controller 20 causes the DVD controller 20 to send control signals to the DVD player 10 in response to a child's input actions. The DVD player 10 responds to the signals produced by the DVD controller 20, reads the content of a DVD-Video disc or DVD 14 inserted into the DVD player 10, and causes images to be displayed on the television 12.

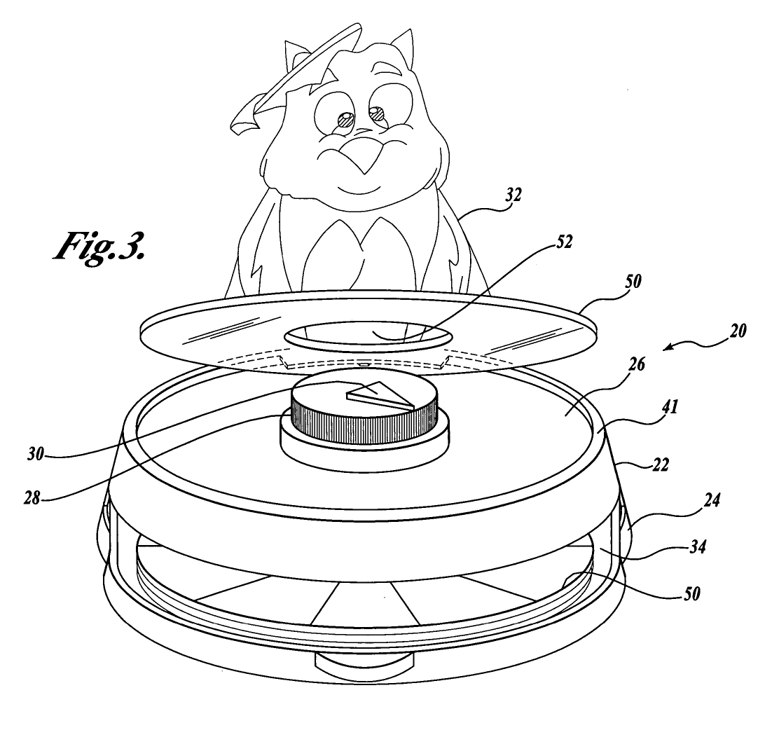

Referring to FIGS. 2 and 3, the DVD controller 20 includes a casing 22 having a base 24 in the form of a truncated cone that defines a circular, horizontal platform 26. Extending upwardly from the base 24 in the center of the platform 26 is a depressible spin dial 28 with a central arrow 30. The platform 26 accepts interchangeable printed discs 50 having multiple different images on them, such as graphical images of farm animals (not shown, but may include cows, horses, chickens, pigs, roosters, etc.). The discs may be printed on both sides, or may be single-sided. Preferably, a character 32, depicted as a caricature of a wise owl, is attached to the base 24. Also, preferably, the casing 22 and the character 32, and other exemplary components, such as the spin dial 28, are molded plastic elements.

When the child-user spins or otherwise moves the arrow 30 of the depressible spin dial 28, such that the arrow 30 points to an image, and depresses the spin dial 28, an infrared (IR) beam 60 causes the DVD player 10 to read the DVD 14, generating a video clip or segment related to the image for display on the television 12. For example, if the child points the central arrow 30 of the dial 28 to the image of a cow and depresses the spin dial 28, the DVD controller 20 sends an IR beam 60 to the DVD player 10, instructing the DVD player 10 to access and play a cow segment stored on the DVD 14. The cow segment may cause a mooing cow to be displayed on the television 12. Additionally, the cow segment might include a host character who introduces the cow segment.

Multiple segments may be stored on the DVD 14, any one of which may be chosen by the DVD controller 20 and displayed on the television 12. For instance, in the cow segment example, when the child-user moves the arrow 30 of the depressible spin dial 28 to point to an image of a cow and depresses the spin dial 28, any one of several segments involving a cow could be generated for display on the television 12. For example, the first cow segment may be of a cow mooing, the second cow segment may be of a farmer milking a cow, the third cow segment may be of a herd of cows grazing in a field, etc. As will be discussed in greater detail below, the decision regarding which segment to display can, depending on design, be made by either the DVD controller 20 or the DVD player 10.

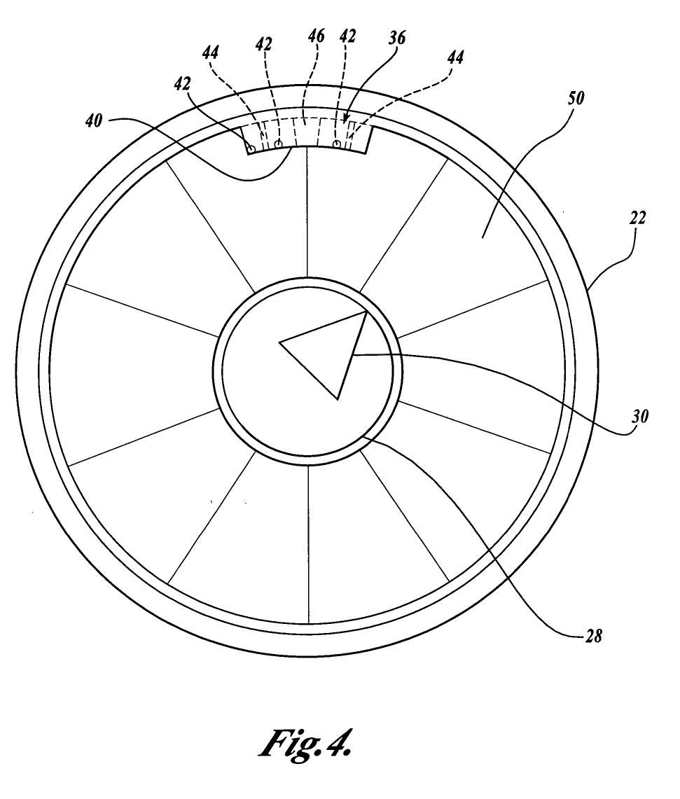

Referring to FIGS. 2-5, the DVD controller 20 will now be described in greater detail. The circular, horizontal platform 26 is sized for receiving a disc 50 with a center hole 52. The center hole 52 is sized to fit over the spin dial 28. The spin dial 28 may be stepped, as shown, or may have the shape of a truncated cone. The spin dial 28 is rotatably mounted in the casing 22 and rotates either in the clockwise or counterclockwise direction, or in both directions, relative to the base 24 and the disc 50. The base 24 includes a storage drawer 34 located beneath the platform 26 for storing discs 50. The storage drawer 34 is positioned in the base 24 opposite the character 32. The storage drawer 34 is shown closed in FIG. 2 and open in FIG. 3. As clearly shown in FIG. 3, the storage drawer 34 is suitable for storing several discs 50. A disc retention and reading assembly 36, located on the exterior perimeter of the casing 22 around the circular platform 26, maintains the disc 50 in position upon the platform 26 during use, and also identifies the inserted disc 50, for example, by reading or sensing the identity of the disc 50. The disc retention and reading assembly 26 also aligns the disc 50 on the platform 26.

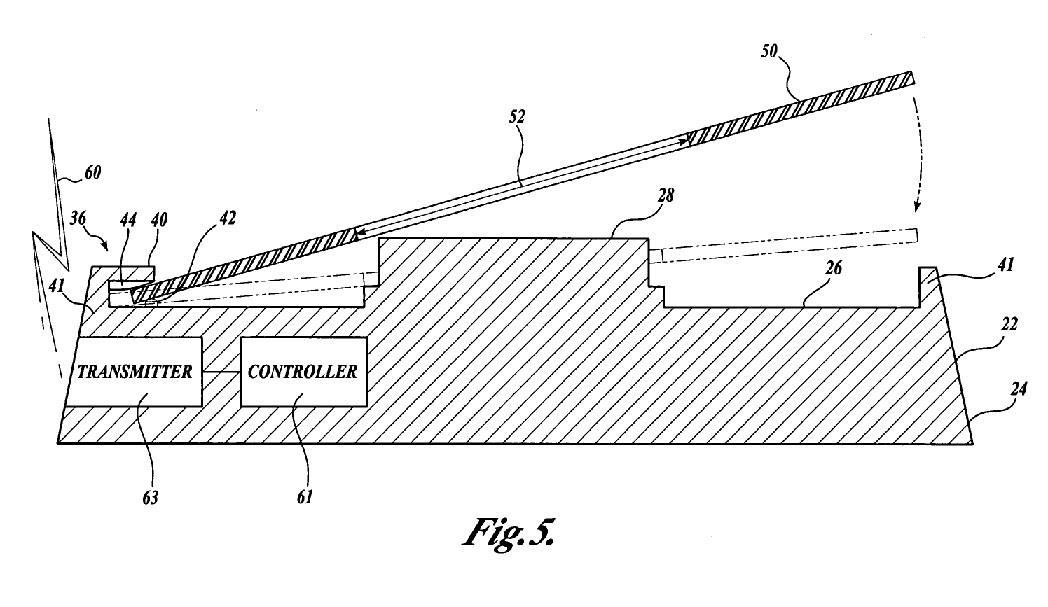

Still referring to FIGS. 3-5, the disc retention and reading assembly 36 will now be described in detail. The disc retention and reading assembly 36 includes a lip 40 located on the exterior perimeter of the outer casing 22, a plurality of spring-loaded sensing pins 42, and two rounded ribs 44. The lip 40 lies atop a wall 41 that surrounds the platform 26 “in front” of the character 32, i.e., on the opposite side of the casing 22 from the drawer 34. The lip 40 covers a relatively small arc, in the range of 30° or so, centered on the centerline of the character 32. The spring-loaded sensing pins 42 lie beneath the lip 40 and are biased in an upward position, but moveable downward by the exertion of longitudinal pressure on the pins 42. The two rounded ribs 44 extend downwardly from the lip 40, and extend radially inwardly from the periphery of the base 24 above the platform 26. The two rounded ribs 44 have rounded lower ends on their inner ends, thereby creating a decreasing distance between the ribs 44 and the platform 26, with the smallest distance at the exterior perimeter of the ribs, as shown in FIG. 5. Thus, the two rounded ribs 44 are positioned to guide and secure a disc 50 under the lip 40 when a disc 50 is slipped into place on the platform 26, as shown in FIG. 5 and described below. Located between the two rounded ribs 44 is a tapered alignment tooth 46. The alignment tooth 46 projects outwardly from the wall 41 that surrounds the platform 26 and lies beneath the lip 40 to maintain an inserted disc 50 in the correct radial position vis-à-vis the platform 26. The alignment tooth 46 may co-act with a slot (not shown) on the disc 50 to align the disc 50 on the platform 26.

A disc 50 is placed on the platform 26 by sliding an edge of the disc 50 underneath the lip 40, the edge containing a tapered depression that mates with the tapered alignment tooth 46. As the disc 50 is guided by the rounded ribs 44, the spring-loaded sensing pins 42 are forced downwardly. As the disk 50 slides beneath the lip 40, the center hole 52 in the disc 50 becomes aligned with the top of the spin dial 28. As this occurs, the outer edge of the disc 50, i.e., the edge remote from the edge lying under the lip 40, drops downwardly until the disc 50 lies flat on the platform 26. When lying on the platform 26, the disc 50 is pressed downwardly by the lip 40 and the two rounded ribs 44 against any upward pressure created by any depressed, spring-loaded sensing pins 42.

The disc 50 is removed by lifting the edge of the disc 50 positioned opposite the edge lying under the lip 40, and sliding the disc 50 out from under the lip 40, i.e., reversing the insertion procedure.

The sensing pins 42 can be in either of two positions, depressed or extended. A sensing pin 42 is depressed if a disc 50 does not include a hole that is aligned with the pin when the disc is inserted. A sensing pin 42 is extended if the disc 50 includes a hole that is aligned with the pin when the disc is inserted. The state of each pin is determined by a suitable sensor, such as a micro switch, an eddy current switch, etc. The state of the pins 42 (extension/depression pattern) forms a binary code that identifies the inserted disc 50 as the disc relates to the DVD disc 14 controlling the DVD player 10. The use of pins should be construed as exemplary, not limiting. The pin sensing mechanism could be replaced with any suitable binary or other coding mechanism, e.g., electro optical, magnetic, etc., which are well known to those familiar with the coding of individual items read by a code reader.

As noted above, the discs 50 are interchangeable, may be double-sided or single-sided, and can cover a variety of areas of interest to children. If double-sided, each unique side of each disc 50 can be identified by a unique identifier or pin extension/depression pattern that corresponds with related video segments stored on the corresponding DVD 14.

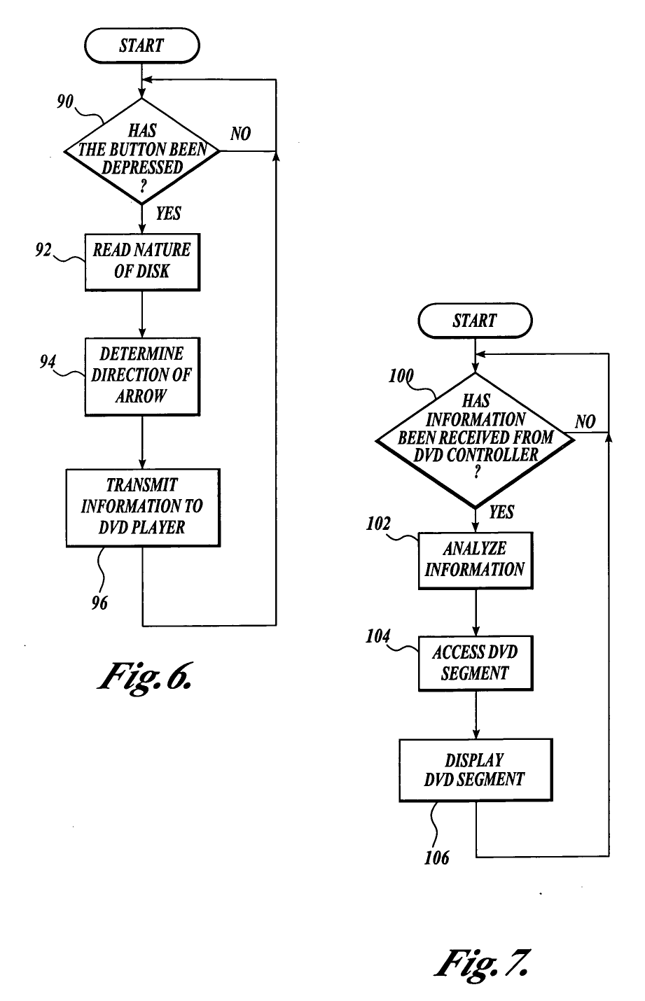

Referring to FIG. 6, the operation of the DVD controller 20 will now be described. The DVD controller 20 includes embedded software included in a controller 61 (FIG. 5) that determines whether the button 28 (i.e., the depressible spin dial) has been pressed, the nature of the disc 50, and the pointing direction of the arrow 30 (i.e., the image the arrow is pointing at). The determined information modulates the IR beam 60 transmitted to the DVD player 10 by a transmitter 63 (FIG. 5) in a conventional manner. More specifically, the software is normally in a wait loop, checking to determine if the button 28 has been depressed to select a graphical image, as shown in FIG. 6 by test block 90. When the software senses that the button 28 has been depressed, the software reads the nature of the disc 50 by reading the extension/depression pattern of the pins 42, as shown by block 92. Then, the direction of the arrow 30 is determined, as shown by block 94. (The functions of blocks 92 and 94 can be reversed, if desired.) The nature of the disc and the direction of the arrow information are transmitted to the DVD player 10, as shown by block 96, i.e., the IR beam 60 is modulated by the nature of the disc 50 and the direction of the arrow information. Thereafter, the software cycles to the wait loop and waits for another button depression.

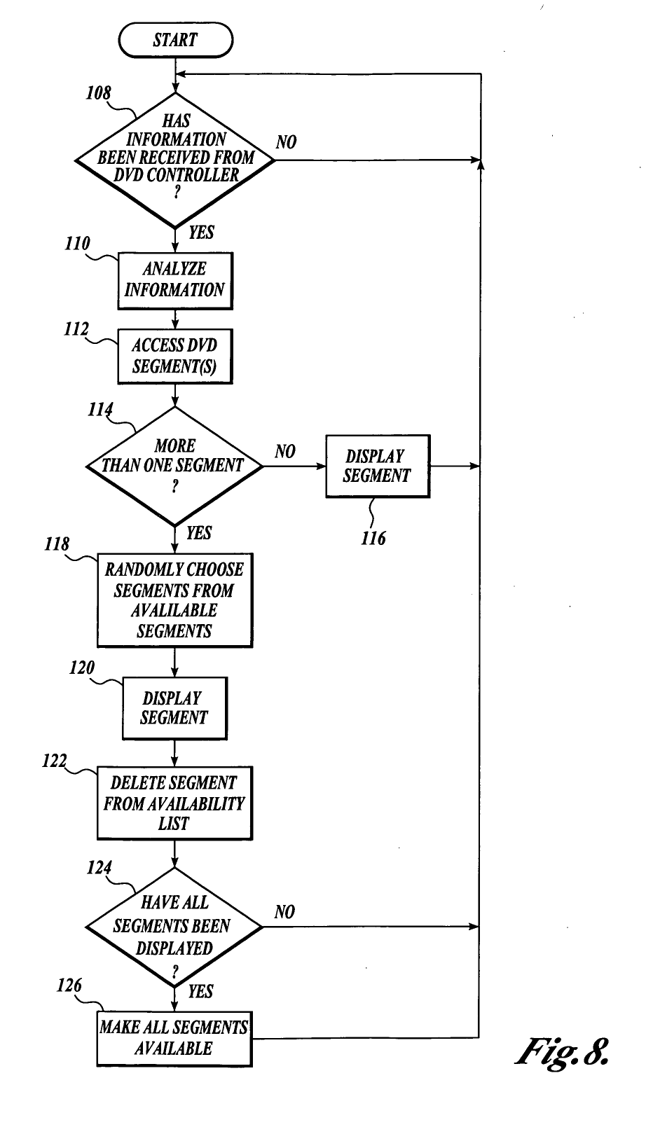

Referring to FIG. 7, the operation of the DVD player 10 in response to information transmitted to the DVD player 10 by the DVD controller 20 will now be described. The DVD player 10 includes embedded software that determines whether information has been received from a DVD controller, such as the DVD controller 20, by detecting an IR beam 60; analyzes the received IR beam 60 for information from the DVD controller 20; accesses the segment of the DVD 14 corresponding to the selected image on the disc 50; and causes the DVD segment to be displayed on the television 12. More specifically, the software is normally in a wait loop, checking to determine if information has been received from the DVD controller 20, as shown in FIG. 7 by test block 100. When information is received, the software analyzes the information to determine the nature of the disc 50 and the segment pointed to by the arrow, as shown by block 102. The result of the analysis is used to access the appropriate DVD segment, as shown by block 104. Then, the accessed segment is displayed as shown by block 106. Thereafter, the software cycles back to the wait loop and waits for more information from the DVD controller 20.

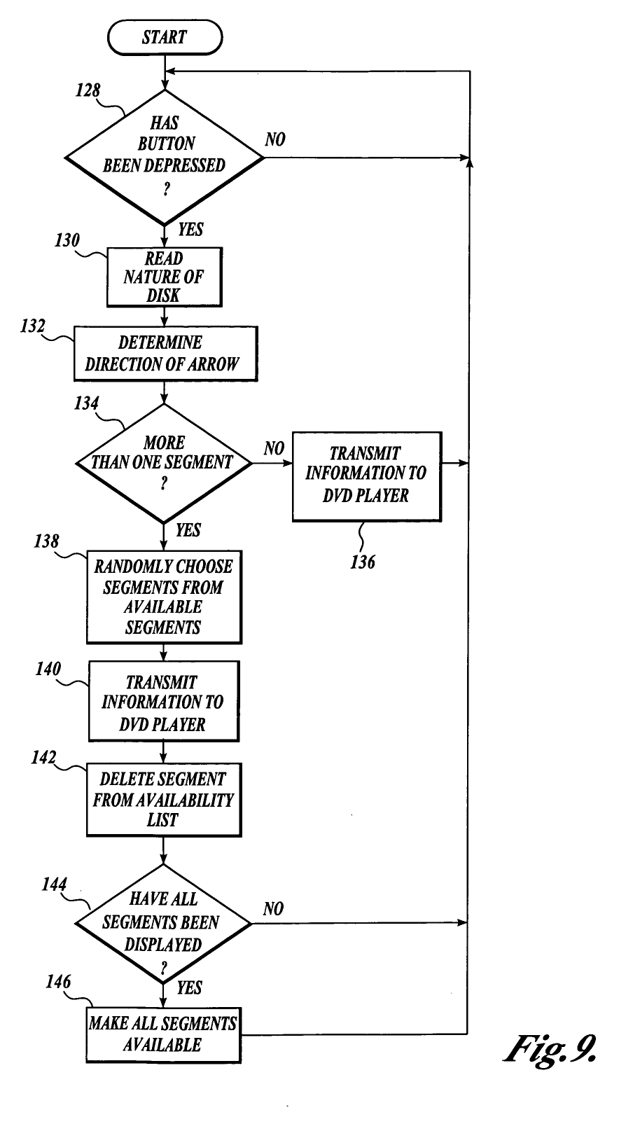

FIG. 8 illustrates an alternative operation of the DVD player 10 in response to information transmitted to the DVD player 10 by the DVD controller 20. The alternative operation of the DVD player 10 allows for the selection of a segment from a group of multiple segments stored on the DVD 14 corresponding to the selected image on the disc 50. The illustrated operation randomly selects a segment for available multiple segments until all segments have been selected. Thus, all segments are selected before segments that have already been played are repeated.

As with FIG. 7, the DVD player 10 includes embedded software that determines whether information has been received from a DVD controller, such as the DVD controller 20, by detecting an IR beam 60; analyzes the received IR beam 60 for information from the DVD controller 20; accesses the segment(s) of the DVD 14 (FIG. 1) corresponding to the selected image on the disc 50; determines if there is more than one segment of the DVD 14 corresponding to the selected image on the disc 50; and, if more than one, randomly selects an image in a manner that results in all images being detected before an image is repeated. More specifically, the software is normally in a wait loop, checking to determine if information has been received from the DVD controller 20, as shown in FIG. 8, by block 108. When information is received, the software analyzes the information to determine the nature of the disc and the segment pointed to by the arrow, as shown by block 110. The result of the analysis is used to access the appropriate DVD segment or segments, as shown by block 112. Then, the DVD player 10 determines if there is more than one segment on the DVD 14 that corresponds to the selected image on the disc 50, as shown by block 114.

If there is only one segment, FIG. 8 functions like FIG. 7 in that the embedded software causes the DVD segment to be displayed on the television 12, as shown by block 116 (similar to block 106, discussed above). Thereafter, the software cycles back to the wait loop and waits for more information from the DVD controller 20.

If there is more than one segment related to the direction of the arrow 30 (i.e., the image the arrow is pointing at, such as a cow), the DVD player 10 randomly chooses a segment from a list of available segments, as shown by block 118; causes the chosen DVD segment to be displayed on the television 12, as shown by block 120; deletes the segment from the list of available segments, as shown by block 122; and determines if all segments have already been displayed, as shown by block 124. If all segments have not been displayed, the software cycles back to the wait loop and waits for more information from the DVD controller 20. If all segments have been displayed, all segments are made available, as shown by block 126, and the software cycles back to the wait loop and waits for more information from the DVD controller 20.

Exemplary methods of randomly selecting a segment from a group of multiple segments stored on the DVD 14 and corresponding to the selected image on the disc 50 are described in U.S. Patent Publication No. 2005/0026699 A1 and U.S. Pat. No. 6,987,925, the disclosures of which are hereby expressly incorporated by reference.

Rather than the random selection employing software embedded in the DVD player 10, the random selection can occur in the DVD controller 20, employing, in essence, the same functionality illustrated in FIG. 8, as shown in FIG. 9. Like FIG. 6, the DVD controller 20 includes embedded software that determines whether the button 28 (i.e., the depressible spin dial) has been pressed, the nature of the disc 50, and the pointing direction of the arrow 30 (i.e., the image the arrow is pointing at). The determined information modulates the IR beam 60 transmitted to the DVD player 10 in a conventional manner. More specifically, the software is normally in a wait loop, checking to determine if the button 28 has been depressed, as shown in FIG. 9, by test block 128. When the software senses that the button 28 has been depressed, the software reads the nature of the disc 50 by reading the extension/depression pattern of the pins 42, as shown by block 130. Then, the direction of the arrow 30 is determined, as shown by block 132. (The functions of blocks 92 and 94 can be reversed, if desired.) Then the DVD player 10 determines if there is more than one segment of the DVD 14 that corresponds to the selected image on the disc 50, as shown by block 134.

If there is only one segment, FIG. 9 functions like FIG. 6 in that the embedded software causes the nature of the disc and the direction of the arrow information to be transmitted to the DVD player 10, as shown by block 136, i.e., the IR beam 60 is modulated by the nature of the disc and the direction of the arrow information. Thereafter, the software cycles to the wait loop and waits for another button depression.

If there is more than one segment related to the direction of the arrow 30 (i.e., the image the arrow is pointing at, such as a cow), the DVD controller 20 randomly chooses a segment from a list of available segments, as shown by block 138; transmits the nature of the disc and the direction of the arrow information to be transmitted to the DVD player 10, thereby causing the chosen DVD segment to be displayed on the television 12, as shown by block 140; deletes the segment from the list of available segments, as shown by block 142; and determines if all segments have already been displaced, as shown by block 144. If all segments have not been displayed, the software cycles back to the wait loop and waits for another depression of the button of the DVD controller 20. If all segments have been displayed, all segments are made available, as shown by block 136, and the software cycles back to the wait loop and waits for another depression of the button of the DVD controller 20.

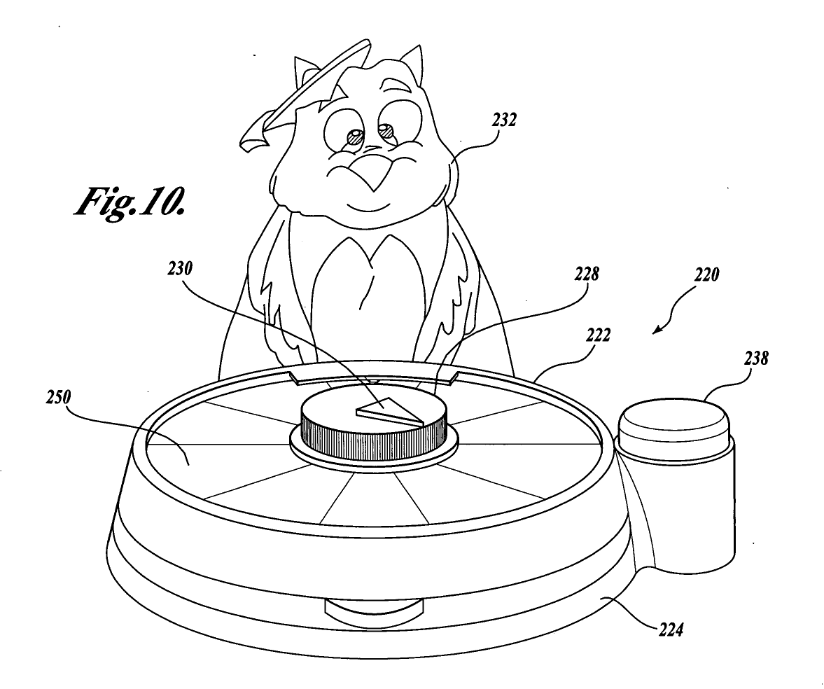

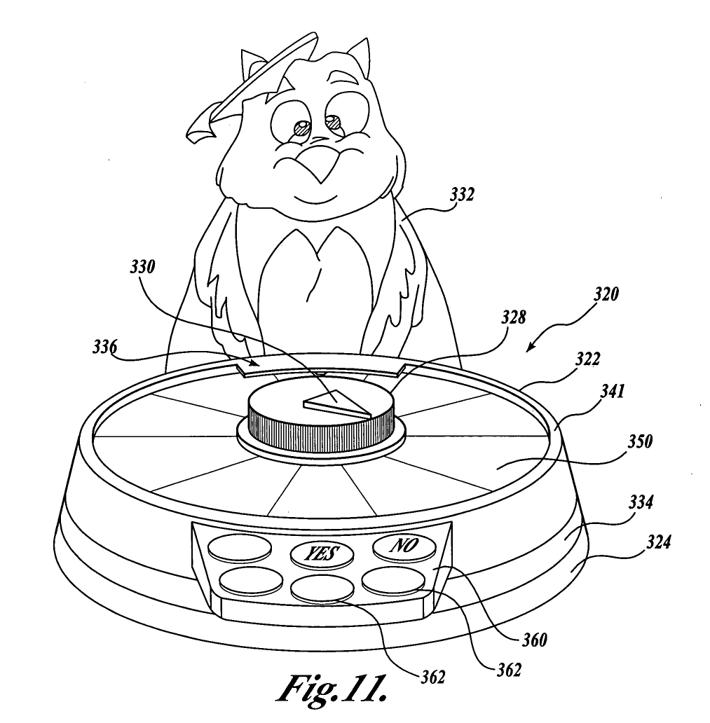

FIG. 10 illustrates a first alternative embodiment of a DVD controller 220 constructed in accordance with the present invention. The first alternative DVD controller 220 illustrated in FIG. 10 is substantially identical in materials and operation to the DVD controller illustrated in FIGS. 2-5 and previously described, with the exception that the first alternative DVD controller 220 includes a side button 238 for image selection, rather than a depressible spin dial. That is, the spin dial 228 of the first alternative DVD controller 220 is not depressible; rather, it is only rotatable to point an arrow 230 toward the segments of an inserted disc 250. After a disc segment selection is made by rotating the spin dial 228 to the desired position, the side button 238 can be depressed, resulting in the same action that occurred when the depressible spin dial 28 (FIGS. 2-5) was depressed.

The side button 238 is located along the outer perimeter of the casing 222 of the alternative DVD controller 220. This embodiment is intended to help improve child-user dexterity in allowing a child to use both left and right hands. For example, a child can spin the dial 228 with his or her right hand and press the button 238 with his or her left hand.

FIG. 11 illustrates a second alternative embodiment of a DVD controller 320 constructed in accordance with the present invention. The second alternative DVD controller 320 illustrated in FIG. 11 is also substantially identical in materials and operation to the DVD controller illustrated in FIGS. 2-5 and previously described, with the exception that the second alternative DVD controller 320 includes a side panel keypad 360 including multiple depressible buttons 362, for interactive play by the child-user. Although the illustrated embodiment includes six depressible buttons 362 on the keypad 360, it should be appreciated that other embodiments including more or fewer than six depressible buttons 362 on the keypad 360 are also within the scope of the invention.

The keypad 360 may be used for simple idea branching, with each printed disc 350 identifying specific answers to questions asked of the child-user during the video segment. For example, an inserted disc 350 may have a series of animals on it, and the spin dial 230 may be pointed at a dog image on the disc 350. Pressing down on the spin dial 330 while it is pointed at the dog image delivers a dog segment (or one of several dog segments) stored on the associated DVD 14. The end of the dog segment includes a series of questions regarding the dog and/or the dog segment, e.g., “Do you want to see the dog perform a trick?” Pressing one of the buttons 362 on the keypad 360, for example, marked “YES,” sends a signal to the DVD player to play a segment like this: “You said yes, so here is the dog performing a trick,” and a dog trick video segment will play. Pressing one of the buttons 362 on the keypad 360, for example, marked “NO,” returns the game to the start screen. If there is no response from the child-user within a short period of time (e.g., one minute), the game will revert back to a start screen.

The insertable disc 350 may include an extension that covers the keypad 360. In this embodiment, the extension of the insertable disc 350 includes holes through which the depressible buttons 362 protrude. Thus, the identifications of the buttons 362 may vary, and can be customized to fit the requirements of individual discs 350. For example, if an insertable disc 350 involves shapes, each depressible button 362 can be identified with a certain shape (e.g., one button is identified with a triangle, another button is identified with a square, another button is identified with a circle, etc.). When the child-user is prompted to “press the square button” by the video segment, another video segment would respond “That's right” to a correct response by the user, or “Try again” to an incorrect response by the user.

All embodiments of the DVD controller work in conjunction with any of the above-mentioned embodiments to control the operation of the DVD player 10 in response to information transmitted to the DVD player 10 by the DVD controller 20.

While illustrative embodiments have been illustrated and described, it will be appreciated that various changes can be made therein without departing from the spirit and scope of the disclosure. For example, while the disc 50 is illustrated as having a circular configuration, the outer periphery of the disc could have other configurations, such as square or hexagonal, for example, and the platform changed to accommodate such other configuration. Hence, within the scope of the appended claims it is to be understood that the invention can be practiced otherwise than as specifically described herein.

1. A controller for use with a multimedia device, comprising:
(a) a platform for receiving a disc, the disc including a plurality of graphical images on at least one surface that correspond to a plurality of multimedia options, the disc also including an identifier that identifies the disc;
(b) a reader for reading the identity of the disc;
(c) a selector for a user to select one of the plurality of graphical images; and
(d) a controller/transmitter for determining the selected graphical image and transmitting a multimedia control signal that contains information that identifies the selected graphical image.

2. The controller of claim 1, wherein the platform includes a platform disc alignment mechanism for controlling the orientation of the disc that co-acts with a disc alignment mechanism included in the disc.

3. The controller of claim 2, wherein the platform disc alignment mechanism comprises a tooth and the disc alignment mechanism comprises a corresponding slot.

4. The controller of claim 1, wherein:
the platform is generally circular and has a rim and a center protrusion; and
the disc is generally circular and has a center hole for receiving the center protrusion.

5. The controller of claim 1, wherein the disc identifier comprises a region containing one or more holes and the reader includes a plurality of depressible pins positioned in the platform so as to detect the one or more holes that identify the disc.

6. The controller of claim 1, wherein the selector includes a spin dial and a selection button.

7. The controller of claim 1, wherein the selector includes a plurality of answer selection buttons.

8. The controller of claim 7, wherein the actuation of a selected answer selection button generates a response to a question related to one of the plurality of graphical images, and wherein the controller/transmitter detects the response and transmits a multimedia control signal that contains the response.

9. The controller of claim 1, further comprising disc storage for storing a plurality of discs.

10. An educational/entertainment apparatus comprising:
(a) a multimedia device for displaying video clips in response to control signals;
(b) a disc including a plurality of graphical images on at least one surface that are related to the video clips, the disc including an identifier that identifies the disc; and
(c) a controller, the controller including:
(i) a platform for receiving the disc;
(ii) a reader for reading the identity of the disc;
(iii) a selector for a user to select one of the plurality of graphical images; and
(iv) a controller/transmitter for determining the selected graphical image and transmitting a multimedia control signal to the multimedia device, the multimedia control signal causing the multimedia device to play a video clip.

11. The educational/entertainment apparatus of claim 10, wherein the platform and the disc include a disc alignment mechanism to align the disc on the platform.

12. The educational/entertainment apparatus of claim 11, wherein the disc alignment mechanism comprises a tooth on the platform and a slot in the disc.

13. The educational/entertainment apparatus of claim 10, wherein:
the platform is generally circular and is surrounded by a rim and has a center protrusion; and
the disc is generally circular and has a central hole for receiving the center protrusion.

14. The educational/entertainment apparatus of claim 10, wherein:
the disc identifier includes one or more holes located in a predetermined region of the disc; and
the reader includes a plurality of depressible pins positioned in the platform so as to detect the one or more holes that identify the disc.

15. The educational/entertainment apparatus of claim 10, wherein the selector includes a spin dial and a selection button.

16. The educational/entertainment apparatus of claim 10, wherein the selector includes a plurality of answer selection buttons.

17. The controller of claim 16, wherein the actuation of a selected answer selection button generates a response to a question related to one of the plurality of graphical images or the video clip, and wherein the controller/transmitter detects the response and transmits a multimedia control signal that contains the response.

18. The educational/entertainment apparatus of claim 10, wherein the controller includes disc storage for storing a plurality of discs.

19. The educational/entertainment apparatus of claim 10, wherein the multimedia device includes a DVD player.

20. The educational/entertainment apparatus of claim 19, wherein, in response to the receipt of a multimedia control signal from the controller/transmitter, the DVD player:
(a) analyzes the multimedia control signal;
(b) based on the analysis, selects a DVD segment to play; and
(c) causes the selected DVD segment to be displayed.

21. The educational/entertainment apparatus of claim 19, wherein, in response to the receipt of a multimedia control signal from the controller/transmitter, the DVD player:
(a) analyzes the multimedia control signal;
(b) based on the analysis, selects one or more DVD segments to play;
(c) determines if only one DVD segment has been selected;
(d) if only one DVD segment has been selected, causes the selected DVD segment to be played;
(e) if more than one DVD segment has been selected, randomly chooses one of the selected segments and causes the randomly selected segment to be played.

22. The educational/entertainment apparatus of claim 21 including, after the randomly selected DVD segment has been selected and displayed:
(a) deleting the randomly selected DVD segment from an availability list;
(b) determining if all of the DVD segments on the availability list have been played;
(c) if all of the DVD segments on the availability list have been selected, making all of the DVD segments on the list available for subsequent random selection.

23. The educational/entertainment apparatus of claim 19, wherein the transmitter/controller:
(a) determines if the selected graphical image is associated with one DVD segment or a list of DVD segments;
(b) if the selected graphical image is associated with only one DVD segment, causes the multimedia control signal to contain information identifying the DVD segment;
(c) if the selected graphical image is associated with a list of DVD segments, randomly selects a DVD segment from the list, and causes the multimedia control signal to contain information identifying the randomly selected DVD segment.

24. The educational/entertainment apparatus of claim 23 including, after the multimedia control signal containing the information identifying the randomly selected DVD segment has been sent:
(a) deleting the randomly selected DVD segment from the list;
(b) determining if all of the DVD segments on the list have been selected;
(c) if all of the DVD segments on the list have been selected, reconstituting the list.

25. The educational/entertainment game, comprising:
(a) a DVD-Video disc containing a plurality of video clips;
(b) a disc including a plurality of graphical images on at least one surface that are related to the video clips, the disc including an identifier that identifies the disc; and
(c) a controller, the controller including:
(i) a platform for receiving the disc;
(ii) a reader for reading the identity of the disc;
(iii) a selector for a user to select one of the plurality of graphical images; and
(iv) a controller/transmitter for determining the selected graphical image and transmitting a multimedia control signal to a multimedia device such that the multimedia control signal causes the multimedia device to access and play one of the plurality of video clips on the DVD-Video disc.
